(19) United States
(12) Patent Application Publication
(10) Pub. No.: US 2016/0167913 A1
(43) Pub. Date: Jun. 16, 2016

(54) BANKNOTE TEMPORARY STORAGE MODULE AND REEL ROTATING SPEED CONTROL METHOD THEREOF

(71) Applicant: GRG Banking Equipment Co., Ltd., Guangzhou, Guangdong (CN)

(72) Inventors: Bao Xiao, Guangzhou (CN); Yunfei He, Guangzhou (CN); Qiaoqiao Chen, Guangzhou (CN); Tao Zhang, Guangzhou (CN)

(73) Assignee: GRG Banking Equipment Co., Ltd., Guangzhou, Guangdong (CN)

(21) Appl. No.: 14/436,867

(22) PCT Filed: Jun. 27, 2013
(86) PCT No.: PCT/CN2013/078107

§ 371 Date: Apr. 17, 2015

(30) Foreign Application Priority Data
Nov. 15, 2012 (CN) 201210462149.2

(51) Int. Cl. B65H 29/00; B65H 5/28; G07D 11/00

(52) U.S. Cl. CPC B65H 29/006; G07D 11/0081; B65H 5/28; B65H 2301/4191; B65H 2513/104; B65H 2513/11; B65H 2553/51; B65H 2701/1912

(57) ABSTRACT

A banknote temporary storage module is provided, including large and small reels driven by first and second power motors respectively, a coiling tape, first and second coded discs, first and second sensors and a microcontroller. The first and second coded discs are fixed on rotating shafts of the large and small reels respectively. The first and second sensors are arranged corresponding to the first and second coded discs respectively and are used for monitoring rotating angles of the large and small reels respectively. The microcontroller is used for calculating the length of the coil tape released by the small reel each time the large reel rotates for one circle, and calculating the current radius of the large reel, and thus angular velocities of the large and small reels are controlled to make the linear velocity of the large reel consistent with that of the small reel.

The present application claims the priority to Chinese Patent Application No. 201210462149.2, entitled “BANKNOTE TEMPORARY STORAGE MODULE AND REEL ROTATING SPEED CONTROL METHOD THEREOF”, filed on Nov. 15, 2012 with the Chinese State Intellectual Property Office, which is incorporated herein by reference in its entirety.

### FIELD

The disclosure relates to the field of control of a financial self-service apparatus, and in particular to a banknote temporary storage module and a method for controlling a rotation speed of a reel of the banknote temporary storage module for an automated teller machine.

### BACKGROUND

A temporary storage module is provided in a cash automatic recycler. The temporary storage module temporarily stores banknotes in transaction. The common temporary storage module usually includes a reel/tape coiling mechanism. The temporary storage module includes a large reel driven by a first power motor, a small reel driven by a second power motor, and a tape coiling. Two ends of the tape coiling are fixed on the large reel and the small reel respectively and the tape coiling is retractably wound between the large reel/the small reel. The first motor and the second motor are controlled to be started or stopped by a microcontroller. This temporary storage module achieves temporary storage of the banknotes by cooperation of the reels and the tape coiling.

The operational process of the temporary storage module is as follows. When a banknote enters into the temporary storage module, the microcontroller issues a command “start”, to make the first motor rotate in a forward direction and the second motor rotate in a reverse direction, the small reel releases the tape coiling and the large reel retracts the tape coiling so that the reels bring the banknote into the temporary storage module through the tape coiling. The microcontroller transmits a command “stop” to stop the first motor and the second motor if no new banknote enters into the temporary storage module after a preset running period t. When the banknote leaves the temporary storage module, the microcontroller issues a command “start” to make the first motor rotate in a reverse direction and the second motor rotate in a forward direction, the large reel releases the tape coiling and the small reel retracts the tape coiling so that the reels bring the banknote out of the temporary storage module through the tape coiling. The microcontroller issues a command “stop” to stop the first motor and the second motor after all banknotes in the temporary storage module are brought out. When the banknote enters into the temporary storage module, the small reel releases the tape coiling and the large reel retracts the tape coiling, the tape coiling is slack if the linear speed of the small reel is greater than the linear speed of the large reel, i.e., the small reel releases the tape coiling faster than the large reel retracts the tape coiling, and the tape coiling is tightened if the linear speed of the small reel is smaller than the linear speed of the large reel, i.e., the large reel retracts the tape coiling faster than the small reel releases the tape coiling. Similarly, when the banknote leaves the temporary storage module, the large reel releases the tape coiling and the small reel retracts the tape coiling, the tape coiling is slack if the linear speed of the large reel is greater than the linear speed of the large reel, i.e., the large reel releases the tape coiling faster than the small reel retracts the tape coiling, and the tape coiling is tightened if the linear speed of the large reel is smaller than the linear speed of the small reel, i.e., the large reel releases the tape coiling slower than the small reel retracts the tape coiling. The slack tape coiling is apt to cause banknote jam, thereby causing device malfunction and increasing manual maintenance. The tightened tape coiling is vulnerable and increases motor load, thereby being apt to damage hardware circuits, cause device malfunction and increase manual maintenance. The effect is best if the linear speeds of the large reel/the small reel are consistent, i.e., the released tape coiling is just completely retracted, in a process that the banknote enters into or leaves the temporary storage module.

The speed at which the tape coiling delivers the banknote and the speed at which other banknote delivery path delivers the banknote need to be constant and consistent during operation of the device. According to the circular motion principle, linear speed v=angular speed ω*radius r. To keep a constant banknote delivering speed of the tape coiling, i.e., to keep the linear speeds of the large reel and the small reel constant, angular speeds of the first motor and the second motor need to be adjusted timely based on radius change of the large reel and the small reel since radiuses of the large reel and the small reel are continually changed as the tape coiling is released and retracted between the large reel and the small reel. The radius increase of the small reel is constant and is equal to the thickness of the tape coiling for one round that the small reel rotates. The radius increase ΔX of the large reel is equal to the thickness of the tape coiling plus the thickness of the banknote for one round that the large reel rotates. ΔX cannot be accurately calculated, i.e., the rotation radius of the large reel after the banknote enters into the large reel cannot be accurately calculated, since spaces between the banknotes are different and thicknesses of the banknotes are different. In an existing method for controlling the temporary storage module, the radius increase ΔX of the large reel is usually estimated by using an empirical value. The angular speeds of the first motor and the second motor are continuously adjusted based on the estimated radius change ΔX of the large reel and the determined radius change of the small reel, to ensure that both the linear speeds of the large reel and the small reel are close to the speed of the path. This control method has the following disadvantages.

The linear speed of the small reel can be ensured to be constant by adjusting the angular speed of the small reel in a case that the current radius of the small reel is determined. However, the radius change of the large reel is estimated by using an empirical value, therefore the real radius of the large reel cannot be accurately reflected, the angular speed cannot be accurately calculated, and thus the constant linear speed of the large reel cannot be ensured. The difference or even the big difference between the linear speed of the large reel and the linear speed of the small reel is apt to cause slack tape coiling, or increase motor load, thereby damaging hardware circuits, causing fault shutdown and increasing manual maintenance.

### SUMMARY

To maintain constant and consistency of the linear speeds of the large reel and the small reel in the banknote temporary storage module, a method for controlling a rotation speed of a reel of a banknote temporary storage module is provided according to the disclosure, with which radius change of the large reel is calculated in real time and rotation angular speed of the reel is controlled according to a current rotation radius of the large reel, thereby preventing fault shutdown caused by slack tape coiling, reducing loss caused by tightened tape coiling, maintaining normal motor load, reducing circuit damage and enhancing reliability of the banknote temporary storage module.

A banknote temporary storage module is further provided according to the disclosure.

The banknote temporary storage module includes a large reel driven by a first power motor, a small reel driven by a second power motor, and a tape coiling, where two ends of the tape coiling are fixed on the large reel and the small reel respectively and the tape coiling is retractably wound between the large reel/the small reel. The banknote temporary storage module further includes: a first encoding disk fixed on a rotating shaft of the large reel, a second encoding disk fixed on a rotating shaft of the small reel, a first sensor arranged corresponding to the first encoding disk and configured to monitor a rotation angle of the large reel, a second sensor arranged corresponding to the second encoding disk and configured to monitor a rotation angle of the small reel, and a microcontroller configured to calculate, based on output signals of the first sensor and the second sensor, a length of a portion of the tape coiling released by the small reel for every one round that the large reel rotates, and calculate a current radius of the large reel, to adjust and control angular speeds of the large reel and the small reel to make a linear speed of the large reel the same as a linear speed of the small reel.

Preferably, the microcontroller includes a storage unit configured to store a radius of the small reel for each round of the small reel and angular speed information of the first motor and the second motor for each round.

Preferably, the microcontroller further includes a pulse counter and a rotation round counter which correspond to the large reel, and a pulse counter and a rotation round counter which correspond to the small reel, where the pulse counters are respectively configured to record triggering to the large reel/the small reel, and the rotation round counters are respectively configured to record the number of rounds that the large reel/the small reel rotate.

Preferably, the banknote temporary storage module further includes a photoelectricity sensor configured to detect whether there is a banknote that enters into the banknote temporary storage module.

The method for controlling a rotation speed of a reel of a banknote temporary storage module includes following steps.

Step 1 includes: a banknote entering into the temporary storage module; a large reel retracting a tape coiling; and recording the number of rounds x that a small reel rotates during one round that the large reel rotates in a current state.

Step 2 includes: calculating a length lengthₓ of a portion of the tape coiling released by the small reel based on the number of rounds that the small reel rotates and a radius of the small reel for each round of the small reel, where

$$\begin{matrix}{length}_{x} = {c}_{1} + {c}_{2} + … + {c}_{x} \\ = 2 π {r}_{0} + 2 π {r}_{1} + … + 2 π {r}_{x - 1} \\ = 2 π r + 2 π ( r - thick ) + … + 2 π [ r - ( x - 1 ) thick ] \\ = 2 π rx - x ( x - 1 ) {π}^{*} thick ;\end{matrix}$$

where c is a perimeter of the small reel for ever one round that the small reel rotates, thick is a thickness of the tape coiling, r is an initial radius of the small reel, and the radius r of the small reel decreases by one thickness of the tape coiling for every one round that the small reel rotates during a process that a banknote enters into the temporary storage module, and the radius of the small reel for each round of the small reel is pre-stored as an array in a storage unit of a microcontroller.

Step 3 includes: calculating a current radius of the large reel based on the length of the portion of the tape coiling released by the small reel, where the length of the portion of the tape coiling released by the small reel is completely retracted by the large reel, where

$$\begin{matrix}{R}_{1} = {length}_{1} / ( 2 π ) \\ = {length}_{x} / ( 2 π ) \\ = [ 2 π rx - x ( x - 1 ) {π}^{*} thick ] / ( 2 π ) .\end{matrix}$$

Step 4 includes: adjusting an angular speed ω₂=ν)/R₁ of a next round based on a current radius of the large reel, where ν is a preset target linear speed of the large reel/the small reel.

Preferably, the method further includes: step 5 which includes recording the radius of the large reel for each round of the large reel during a process that the banknote enters into the banknote temporary storage module; and step 6 which includes during a process that the banknote leaves the temporary storage module, the large reel releasing the tape coiling, and adjusting an angular speed of the large reel for each round that the large reel rotates based on the radius of the large reel for each round of the large reel recorded in step 5.

Preferably, the method for controlling the rotation speed of the reel of the banknote temporary storage module further includes a method for controlling a rotation speed of a small reel which includes: S201 which includes a system starting to operate, a banknote entering into the temporary storage module, the reel running, a microcontroller monitoring an encoding disk of the small reel by an electric signal fed back by a second sensor, determining whether a pulse triggering is detected, performing S202 if the pulse triggering is detected by the microcontroller and returning to S201 if no pulse triggering is detected by the microcontroller; S202 which includes increasing a pulse counter of the small reel by one; S203 which includes determining whether pulse count of the small reel is equal to one round, performing S204 if the pulse count of the small reel is equal to one round and returning to S201 if the pulse count of the small reel is not equal to one round; S204 which includes increasing the number of rounds that the small reel rotates by one; S205 which includes updating a rotation radius of the small reel by decreasing the radius of the small reel by one thickness of the tape coiling for every one round that the small reel rotates, and recording the rotation radius of the small reel for each round that the small reel rotates into an array in the storage unit set in the microprocessor; S206 which includes outputting a rotation speed of the small reel, calculating an angular speed ωₙ=ν/rₙ₋₁ (n is a natural number) of the small reel for each round that the small reel rotates according to circular motion principle, outputting the calculated angular speed to a second motor corresponding to the small reel to control the rotation speed of the small reel, and performing S207; and S207 which includes monitoring whether the rotation speed of the small reel is abnormal, determining that the small reel is overspeed if it is monitored that the rotation speed of the small reel is greater than the output theoretical rotation speed and determining that the small reel is stalled if it is monitored that the rotation speed of the small reel is smaller than the output theoretical rotation speed; and if the rotation speed of the small reel is abnormal, stopping power motors of the large reel and the small reel, or otherwise returning to S201.

Controlling the rotation speed of the large reel includes: S301 which includes a system starting to operate, a banknote entering into the temporary storage module, the reel running, the microcontroller monitoring an encoding disk of the large reel by an electric signal fed back by a first sensor, determining whether a pulse triggering is detected, performing S302 if the pulse triggering is detected by the microcontroller and returning to S301 if no pulse triggering is detected by the microcontroller; S302 which includes increasing a pulse counter of the large reel by one; S303 which includes determining whether pulse count of the large reel is equal to one round, performing S304 if the pulse count of the large reel is equal to one round and returning to S301 if the pulse count of the large reel is not equal to one round; S304 which includes increasing the number of rounds that the large reel rotates by one; S305 which includes calculating a length of a portion of the tape coiling released by the small reel during the first round that the large reel rotates; S306 which includes calculating and updating a radius of the large reel, and recording the radius of the large reel into a large reel radius array in the storage unit set in the microprocessor; S307 which includes outputting a rotation speed of the large reel, calculating an angular speed of the large reel according to ω=ν/R, outputting the calculated angular speed to a first motor corresponding to the large reel to control the rotation speed of the large reel, and performing S308; and S308 which includes monitoring whether the rotation speed of the large reel is abnormal, determining that the large reel is overspeed if the rotation speed of the large reel is greater than the output theoretical rotation speed and determining that the large reel is stalled if the rotation speed of the large reel is smaller than the output theoretical rotation speed; and if the rotation speed of the large reel is abnormal, stopping power motors of the large reel/the small reel, or otherwise returning to S301.

In the disclosure, the radius of the large reel is indirectly calculated by calculating the length of the portion of the tape coiling released by the small reel for each round that the large reel rotates based on the feature that the radius of the smaller reel of the banknote temporary storage module for each round that the small reel rotates can be determined, and the angular speed of the large reel for each round that the large reel rotates is dynamically adjusted, to ensure that the linear speeds of the large reel/the small reel are consistent, thereby preventing fault shutdown caused by slack tape coiling, reducing loss caused by tightened tape coiling, maintaining normal motor load, reducing circuit damage and enhancing reliability of the banknote temporary storage module.

### BRIEF DESCRIPTION OF THE DRAWINGS

The disclosure is further described in the following in conjunction with drawings and embodiments.

FIG. 1 is a schematic structural composition diagram of mechanisms of an automatic teller machine provided according to a preferred embodiment of the disclosure;

FIG. 2 is schematic structural diagram of a banknote temporary storage module provided according to a preferred embodiment of the disclosure;

FIG. 3 is a diagram illustrating a control principle of a banknote temporary storage module;

FIG. 4 is a schematic diagram illustrating that banknotes enter into a temporary storage module;

FIG. 5 is a schematic diagram illustrating that banknotes leave a temporary storage module;

FIG. 6 is a flow chart of controlling a rotation speed of a small reel in a process that banknotes enter into a temporary storage module; and

FIG. 7 is a flow chart of controlling a rotation speed of a large reel in a process that banknotes enter into a temporary storage module.

### DETAILED DESCRIPTION

Technical solutions according to embodiments of the present disclosure will be described completely and clearly in the following with the drawings.

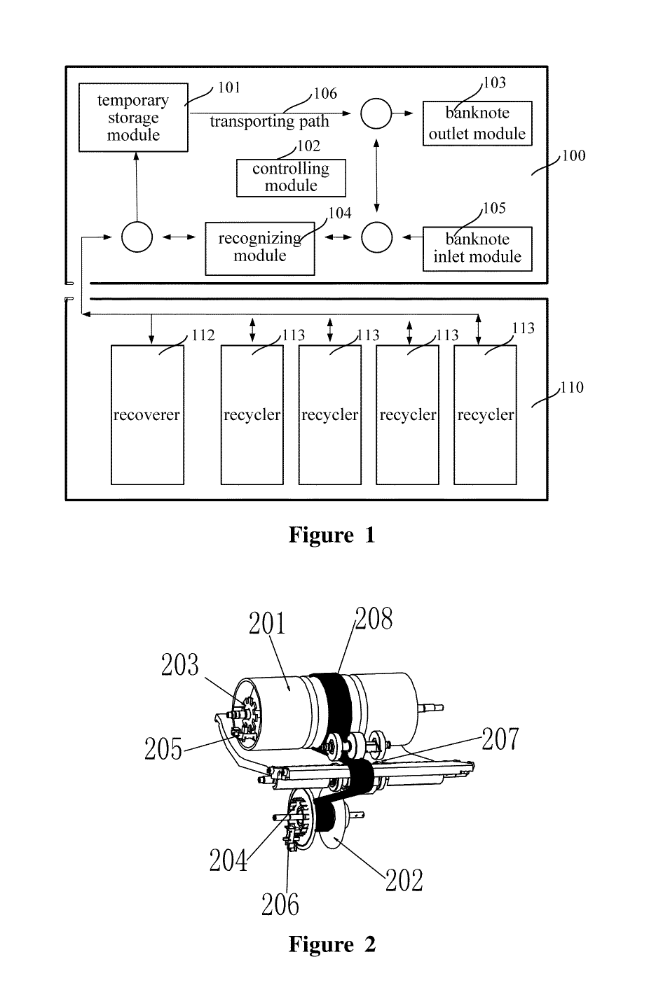

A banknote temporary storage module applied to an automatic teller machine is provided according to a preferred embodiment of the disclosure. As shown in FIG. 1, the automatic teller machine includes an upper mechanism 100 and a lower mechanism 110. The upper mechanism 100 includes a banknote inlet module 105, a banknote outlet module 103, a banknote recognizing module 104, a banknote temporary storage module 101, a banknote transporting path 106 and a mechanism controlling module 102. The lower mechanism includes a recoverer module 112 and recycler modules 113. The upper mechanism 100 is connected to the lower mechanism 110 via the banknote transporting path 106, and the modules are connected to each other via the banknote transporting path 106. The disclosure is to improve the structure of the banknote temporary storage module 101 and propose a method for controlling a rotation speed of a reel, to reach a purpose of maintaining constant and consistency of the linear speeds of the large reel and the small reel in the banknote temporary storage module, thereby preventing the tape coiling from being slack or tightened and improving stability and reliability of the automatic teller machine.

As shown in FIG. 2, the banknote temporary storage module 101 includes: a large reel 201 driven by a first power motor (not shown), a small reel 202 driven by a second power motor (not shown), and a tape coiling 208, where two ends of the tape coiling are fixed on the large reel and the small reel respectively and the tape coiling is retractable wound between the large reel/the small reel. A first encoding disk 203 and a second encoding disk 204 are fixed on rotating shafts of the large reel and the small reel respectively. A first sensor 205 and a second sensor 206 are arranged corresponding to the first encoding disk 203 and the second encoding disk 204 respectively and are configured to monitor rotation angles of the large reel 201 and the small reel 202 respectively. A microcontroller (not shown, which may be integrated in the mechanism controlling module 102) calculates a length of a portion of the tape coiling released by the small reel for each round that the large reel rotates according to output signals of the first sensor 205 and the second sensor 206, and calculates a current radius of the large reel, to adjust and control angular speeds of the large reel and the small reel to make a linear speed of the large reel the same as a linear speed of the small reel. Preferably, the banknote temporary storage module 101 further includes a photoelectricity sensor 207 configured to detect whether there is a banknote that enters into the temporary storage module 101.

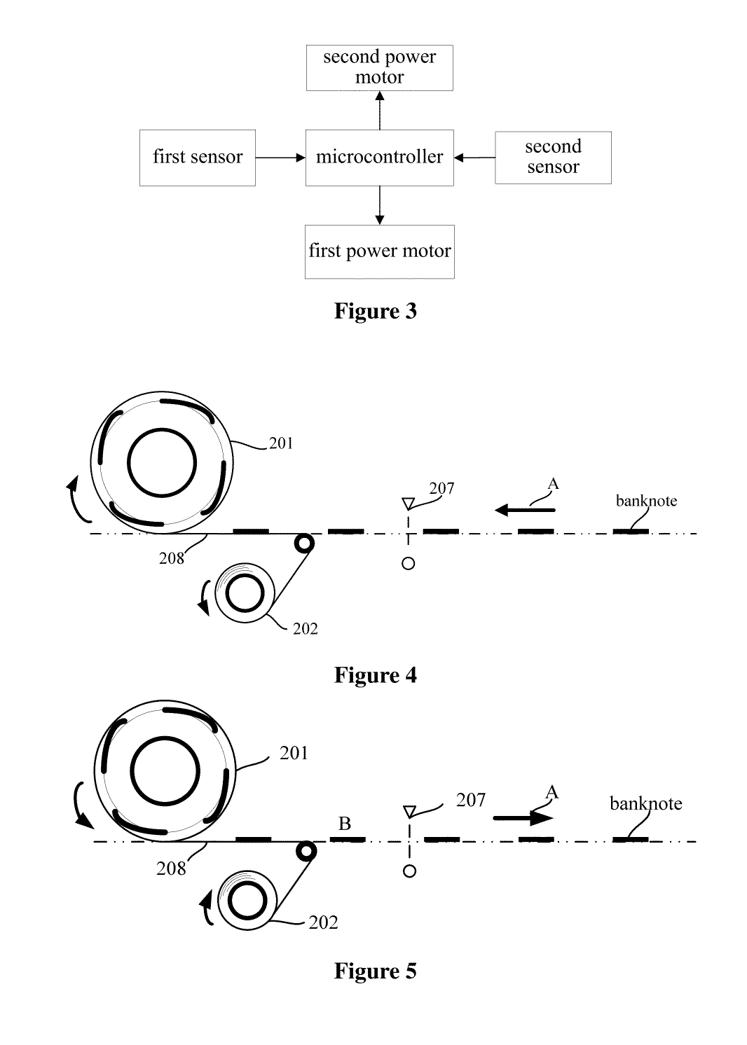

FIG. 3 is a diagram illustrating a principle for controlling a rotation speed of a reel of a temporary storage module. The microcontroller is connected to the first sensor, the second sensor, the first power motor and the second power motor, and is configured to receive information collected by the first sensor and the second sensor, calculate rotation angular speeds of the first power motor and the second power motor and control the first power motor and the second power motor by outputting. The microcontroller is disposed with a storage unit configured to store the radius of the small reel for each round of the small reel and angular speed information of the first motor and the second motor for each round.

The operating principle of the temporary storage module 101 is as follows in conjunction with FIG. 1 to FIG. 5.

Banknotes are delivered to the transporting path 106 after being separated in the banknote inlet module 105, and after the banknotes are recognized by the recognizing module 104, the qualified banknotes are delivered to the temporary storage module 101 via the transporting path 106, and the unqualified banknotes are delivered to the banknote outlet module 103 via the transporting path 106. In a case that it is detected, by a photoelectricity sensor 207 on the front-end of the temporary storage module 101, that there is a banknote that enters into the temporary storage module 101, the photoelectricity sensor 207 transmits a trigger signal of “banknote enters” to the microcontroller, and the microcontroller issues a command “start” to start the first power motor (not shown) and the second power motor (not shown) and notifies a banknote counter to increase by one. If no banknote entering into the temporary storage module 101 is detected by the photoelectricity sensor 207 on the front-end of the temporary storage module 101 after a preset running period t, the microcontroller issues a command “stop” to stop the first power motor and the second power motor.

As shown in FIG. 4, the small reel 202 releases the tape coiling and the large reel 201 retracts the tape coiling in a process that the banknote enters into the temporary storage module. The rotation radius R of the large reel 201 increases and the rotation radius r of the small reel 202 decreases as the banknote enters. According to the circular motion principle, an angular speed ω of the large reel decreases as the rotation radius R of the large reel increases, so a deceleration curve is adopted for speed adjustment of the first motor corresponding to the large reel; and an angular speed ω of the small reel increases as the rotation radius r of the smaller reel decreases, so an acceleration curve is adopted for speed adjustment of the second motor corresponding to the small reel.

In a process that the banknote leaves the temporary storage module, the microcontroller issues a command “start” to start the first power motor and the second power motor. Once it is detected by the photoelectricity sensor 207 on the front-end of the temporary storage module 101 that there is a banknote that leaves, the photoelectricity sensor 207 transmits a trigger signal of “banknote leaves” to the microcontroller, and notifies the banknote counter to decrease by one. After the banknote leaves the temporary storage module and enters into the transporting path 106, the transporting path 106 delivers the banknote to the banknote outlet module 103 or a cashbox of the lower mechanism 110 according to a set workflow. If the banknote counter is equal to 0 and all banknotes in the temporary storage module 101 are delivered out, the microcontroller issues a command “stop” to stop the first power motor and the second power motor.

As shown in FIG. 5, the large reel 201 releases the tape coiling and the small reel 202 retracts the tape coiling in a process that the banknote leaves the temporary storage module 101. As the banknote leaves, the rotation radius R of the large reel 201 decreases and the rotation radius r of the small reel 202 increases. According to the circular motion principle, the angular speed ω of the large reel increases as the rotation radius R of the large reel decreases, so an acceleration curve is adopted for speed adjustment of the first motor corresponding to the large reel; and an angular speed ω of the small reel decreases as the rotation radius r of the smaller reel increases, so a deceleration curve is adopted for speed adjustment of the second motor corresponding to the small reel.

The microcontroller monitors rotation change of the encoding disk 203 of the large reel by an electric signal fed back by the first sensor 205, and records the angle and the number of rounds that the large reel rotates; and monitors rotation change of the encoding disk 204 of the small reel by an electric signal fed back by the second sensor 206, and records the angle and the number of rounds that the small reel rotates. Once the large reel and the smaller rotate one round, the radius of the large reel and the radius of the small reel change. In a process that a banknote enters into the temporary storage module 101, the microcontroller may accurately calculate the length of the portion of the tape coiling 208 released by the small reel 202 according to the angle and the number of rounds that the small reel 202 rotates. Since the portion of the tape coiling 208 released by the small reel 202 is all retracted by the large reel 201, the rotation radius of the large reel 201 for each round that the large reel 201 rotates may be calculated. The microcontroller records the rotation radius of the large reel/the small reel for each round that the large reel/the small reel rotates, and adjusts rotation speeds of the first motor and the second motor respectively corresponding to the large reel/the small reel in real time according to the rotation radius of the large reel/the small reel, to keep the linear speeds of the large reel/the small reel consistent. The process that the banknote leaves the reels is the reverse of the process that the banknote enters into the reels, the microcontroller adjusts the rotation speeds of the first motor and the second motor of the large reel/the small reel in real time according to the rotation radius of the large reel/the small reel recorded when the banknote enters into the reels, to keep the linear speeds of the large reel/the small reel consistent.

The banknote enters into and leaves the temporary storage module normally only if the large reel/the small reel and the tape coiling operate in cooperation with each other. The slack tape coiling is apt to cause banknote jam, thereby causing device malfunction and increasing manual maintenance. The tightened tape coiling is vulnerable and increases motor load, thereby being apt to damage hardware circuits, cause device malfunction and increase manual maintenance. The tape coiling should maintain certain relaxation. The tape coiling may not be too slack or tightened by keeping consistent linear speeds of the large reel/the small reel, so that the temporary storage device may function well.

The principle for controlling the rotation speed of the reel of the temporary storage module 101 is described in detail in the following.

For the process that the reels receive the banknote, the description is as follows.

Firstly, the reels are in an initial state, i.e., the tape coiling is all wound around the small reel 202 but not the large reel 201. Once the photoelectricity sensor 207 detects that a banknote enters, the microcontroller starts the first motor and the second motor to respectively drive the large reel 201 and the small reel 202 to rotate.

The small reel 202 releases the tape coiling and the large reel 201 retracts the tape coiling as the large reel/the small reel rotate, thus the banknote is carried by the tape coiling and is rolled up by the large reel 201. According to the radius of the small reel 202 for each round that the small reel 202 rotates, a length of a portion of the tape coiling released by the small reel 202 and an angular speed of the small reel 202 are calculated. The radius of the small reel for each round of the small reel may be pre-stored as an array in a storage unit of the microcontroller, and may be read according to the corresponding round as needed. Alternatively, the radius of the small reel for each round of the small reel may be stored into the storage unit, after being calculated by decreasing the radius r of the small reel by one thickness of the tape coiling for every one round that the small reel rotates based on the initial radius of the small reel, in the process that the banknote enters into the temporary storage module. Rotation data of the small reel is calculated as follows.

Provided that the initial radius of the small reel 202 is r, the target linear speed of the small reel 202 is ν, and the initial rotation speed of the small reel 202 is ω₁=ν/r₀, where r₀=r.

For the first round: after the small reel 202 rotates one round at a speed of ω₁, it is calculated according to formulas that: the radius r₁ of the small reel 202 is r₁=r−thick, the length c₁ of a portion of the tape coiling released by the small reel 202 is c₁=2πr₀, and the rotation speed ω₂ of the small reel for the second round is ω₂=ν/r1.

For the second round: after the small reel rotates one round at a speed of ω₂, it is calculated according to formulas that: the radius r₂ of the small reel is r₂=r−2*thick, the length c₂ of a portion of the tape coiling released by the small reel is c₂=2πr₁, and the rotation speed ω₃ of the small reel for the third round is ω₃=ν/r₂.

For the (n−1)-th round: after the small reel rotates one round at a speed of ωₙ₋₁, it is calculated according to formulas that: the radius rₙ₋₁ of the small reel is rₙ₋₁=r−(n−1)*thick, the length cₙ of a portion of the tape coiling released by the small reel is cₙ=2πrₙ₋₂, and the rotation speed ωₙ of the small reel for the n-th round is ωₙ=ν/rₙ₋₁.

For the n-th round: after the small reel rotates one round at a speed of ωₙ, it is calculated according to formulas that: the radius rₙ of the small reel is rₙ=r−n*thick, the length cₙ of a portion of the tape coiling released by the small reel is cₙ=2πrₙ₋₁, and the rotation speed ωₙ₊₁ of the small reel for the (n+1)-th round is ωₙ₊₁=ν/rₙ.

Rotation information of the small reel 202 is summarized and presented in table 1.

TABLE 1
Rotation Data of Small reel

| | | | length of portion |
|---|---|---|---|
| | | | of tape coiling |
| | | radius of | released by |
| | | small reel after | small reel after |
| rotation | rotation speed | small reel rotates | small reel rotates |
| round | of small reel | one round | one round |
| the 0 round | 0 | r₀ = r | 0 |
| the first round | ω₁ = υ/r₀ | r₁ = r − thick | c₁ = 2πr₀ |
| the second | ω₂ = υ/r₁ | r₂ = r − 2 * thick | c₂ = 2πr₁ |
| round | | | |
| . . . | . . . | . . . | . . . |
| the (n − 1)-th | ωₙ₋₁ = υ/rₙ₋₂ | rₙ₋₁ = r − (n − 1) * | cₙ₋₁ = 2πrₙ₋₂ |
| round | | thick | |
| the n-th | ωₙ = υ/rₙ₋₁ | rₙ = r − n * thick | cₙ = 2πrₙ₋₁ |
| round | | | |

Then the length of a portion of the tape coiling retracted by the large reel 201 and the radius and the rotation speed of the large reel 201 for each round that the large reel 201 rotates are calculated according to the rotation data of the small reel 202, and the microcontroller outputs the calculated results to the first motor to dynamically control the rotation speed of the large reel 201.

Provided that the initial radius of the large reel 201 is R, the target linear speed of the large reel 201 is ν, and the initial rotation speed of the large reel 201 is ω₁=ν/R₀, where R₀=R.

For the first round: after the large reel rotates one round at a speed of ω₁, the length C₁ of a portion of the tape coiling retracted by the large reel is equal to the length length₁ of the portion of the tape coiling released by the small reel, and it is calculated according to formulas that the radius R₁ of the large reel is R₁=C₁/(2π), and the rotation speed ω₂ of the large reel for the second round is ω₂=ν/R₁.

For the second round: after the large reel rotates one round at a speed of ω₂, the length C₂ of a portion of the tape coiling retracted by the large reel is equal to the length length₂ of the portion of the tape coiling released by the small reel, and it is calculated according to formulas that the radius R₂ of the large reel is R₂=C₂/(2π), and the rotation speed ω₃ of the large reel for the third round is ω₃=ν/R₂.

For the (n−1)-th round: after the large reel rotates one round at a speed of ωₙ₋₁, the length Cₙ₋₁ of a portion of the tape coiling retracted by the large reel is equal to the length lengthₙ₋₁ of the portion of the tape coiling released by the small reel, and it is calculated according to formulas that the radius Rₙ₋₁ of the large reel is Rₙ₋₁=Cₙ₋₁/(2π), and the rotation speed ωₙ of the large reel for the n-th round is ωₙ=ν/Rₙ₋₁.

The n-th round: after the large reel rotates one round at a speed of ωₙ, the length Cₙ of a portion of the tape coiling retracted by the large reel is equal to the length lengthₙ of the portion of the tape coiling released by the small reel, and it is calculated according to formulas that the radius Rₙ of the large reel is Rₙ=Cₙ/(2π), and the rotation speed ωₙ₊₁ of the large reel for the (n+1)-th round is ωₙ₊₁=ν/Rₙ.

The length length₁ of the portion of the tape coiling released by the small reel is calculated as follows.

Provided that the number of rounds that the small reel rotates is x after the large reel rotates one round at a speed of ω₁, and according to calculation formulas for data related to the large reel/the small reel,

the initial radius of the small reel is r,

the radius rₓ of the small reel for the x-th round of the small reel is rₓ=r−x*thick, and

the total length lengthₓ of the portion of the tape coiling released by the small reel is:

$$\begin{matrix}{length}_{x} = {c}_{1} + {c}_{2} + … + {c}_{x} \\ = 2 π {r}_{0} + 2 π {r}_{1} + … + 2 π {r}_{x - 1} \\ = 2 π r + 2 π ( r - thick ) + … + 2 π [ r - ( x - 1 ) thick ] \\ = 2 π rx - x ( x - 1 ) {π}^{*} thick\end{matrix}$$

The tape coiling released by the small reel is equal to the tape coiling retracted by the large reel, so length₁=lengthₓ.

The radius R₁ of the large reel for the first round of the large reel is:

$$\begin{matrix}{R}_{1} = {length}_{1} / ( 2 π ) \\ = {length}_{x} / ( 2 π ) \\ = [ 2 π rx - x ( x - 1 ) {π}^{*} thick ] / ( 2 π )\end{matrix}$$

The rotation speed ω₂ of the large reel for the second round of the large reel is ω₂=ν/R₁.

Provided that the number of rounds that the small reel rotates is y after the large reel rotates one round at a speed of ω₂, and according to the calculation formulas for data related to the small reel,

the initial radius of the small reel is r,

the radius r_{y} of the small reel for the y-th round of the small reel is r_{y}=r−y*thick, and

the total length length_{y} of the portion of the tape coiling released by the small reel is:

$$\begin{matrix}{length}_{y} = {c}_{1} + {c}_{2} + … + {c}_{y} \\ = 2 π {r}_{0} + 2 π {r}_{1} + … + 2 π {r}_{y - 1} \\ = 2 π r + 2 π ( r - thick ) + … + 2 π [ r - ( y - 1 ) thick ] \\ = 2 π ry - y ( y - 1 ) {π}^{*} thick\end{matrix}$$

The tape coiling released by the small reel is equal to the tape coiling retracted by the large reel, so length₂=length_{y}−lengthₓ.

The radius R₂ of the large reel for the second round of the large reel is:

$$\begin{matrix}{R}_{2} = {length}_{2} / ( 2 π ) \\ = ( {length}_{y} - {length}_{x} ) / ( 2 π ) \\ = \{ [ 2 π ry - y ( y - 1 ) {π}^{*} thick ] - [ 2 π rx - x ( x - 1 ) {π}^{*} thick ] \} / ( 2 π )\end{matrix}$$

The rotation speed ω₃ of the large reel for the third round of the large reel is ω₃=ν/R₂.

Provided that the number of rounds that the small reel rotates is z after the large reel rotates one round at a speed of ω₃, and according to the calculation formulas for data related to the small reel,

the initial radius of the small reel is r,

the radius r_{z} of the small reel for the z-th round of the small reel is r_{z}=r−z*thick, and

the total length length_{z} of the portion of the tape coiling released by the small reel is:

$$\begin{matrix}{length}_{z} = {c}_{1} + {c}_{2} + … + {c}_{z} \\ = 2 π {r}_{0} + 2 π {r}_{1} + … + 2 π {r}_{z - 1} \\ = 2 π r + 2 π ( r - thick ) + … + 2 π [ r - ( z - 1 ) thick ] \\ = 2 π rz - z ( z - 1 ) {π}^{*} thick\end{matrix}$$

The tape coiling released by the small reel is equal to the tape coiling retracted by the large reel, so length₃=length_{z}−length_{y}.

The radius R₃ of the large reel for the third round of the large reel is:

$$\begin{matrix}{R}_{3} = {length}_{3} / ( 2 π ) \\ = ( {length}_{z} - {length}_{y} ) / ( 2 π ) \\ = \{ [ 2 π rz - z ( z - 1 ) {π}^{*} thick ] - [ 2 π ry - y ( y - 1 ) {π}^{*} thick ] \} / ( 2 π )\end{matrix}$$

The rotation speed ω₄ of the large reel for the third round of the large reel is ω₄=ν)/R₃.

In a similar way, the rotation radius and rotation speed of the large reel for each round of the large reel may be calculated. The following table 2 shows the rotation data of the large reel 201, including the rotation speed, the radius for each round, and the length of the portion of the tape coiling retracted by the large reel 201.

TABLE 2
Rotation Data of Large reel

| | | | length of |
|---|---|---|---|
| | | | portion of tape |
| | | radius of | coiling retracted |
| | | large reel after | by large reel after |
| | rotation speed | large reel rotates | large reel rotates |
| rotation round | of large reel | one round | one round |
| the 0 round | 0 | R₀ = R | 0 |
| the first round | ω₁ = υ/R₀ | R₁ = C₁/(2π) | C₁ = length₁ |
| the second | ω₂ = υ/R₁ | R₂ = C₂/(2π) | C₂ = length₂ |
| round | | | |
| . . . | . . . | . . . | . . . |
| the (n − 1)-th | ωₙ₋₁ = υ/Rₙ₋₂ | Rₙ₋₁ = Cₙ₋₁/(2π) | Cₙ₋₁ = lengthₙ₋₁ |
| round | | | |
| the n-th round | ωₙ = υ/Rₙ₋₁ | Rₙ = Cₙ/(2π) | Cₙ = lengthₙ |

It can be seen from the above calculation processes that the radius of the large reel/the small reel for each round can be calculated. The radius of the large reel/the small reel for each round is stored into a storage. According to the circular motion principle, the angular speed ω is ω=v/r, the angular speed of the reel is dynamically adjusted according to the rotation radius while keeping constant and consistent linear speed v, where ω_{b}=v/R′ for the large reel and ωₛ=v/r′ for the small reel.

For the process that the reels release the banknote, the description is as follows.

The process that the banknote leaves the banknote temporary storage module is the reverse of the process that the banknote enters into the temporary storage module. The first motor and the second motor are started, the large reel releases the tape coiling and the small reel retracts the tape coiling. As the banknotes leaving the temporary storage module increase, the rotation radius of the large reel gradually decreases, and the rotation radius of the small reel gradually increases. The rotation radius of the large reel/the small reel for each round of the large reel/the small reel is recorded by the system in a process that the banknotes enter into the temporary storage module. After the large reel rotates one round, the radius of the large reel decreases by ΔY which is equal to the thickness of the tape coiling plus the thickness of the banknote. After the small reel rotates one round, the radius of the small reel increases by one thickness of the tape coiling. In a case that the linear speeds of the large reel/the small reel are constant and consistent, the length of the portion of the tape coiling released by the large reel is the same as the length of the portion of the tape coiling retracted by the small reel. According to a principle the same as that of the calculation process for the process that the banknote enters into the temporary module, the radius of the large reel/the small reel for each round which is recorded and stored during the process that the banknote enters into the reel is used, the angular speed is ω=v/r according to the circular motion principle, and the angular speed of the reel is dynamically adjusted according to the rotation radius while keeping constant and consistent linear speed v, where ω_{b}=v/R′ for the large reel and ωₛ=v/r′ for the small reel.

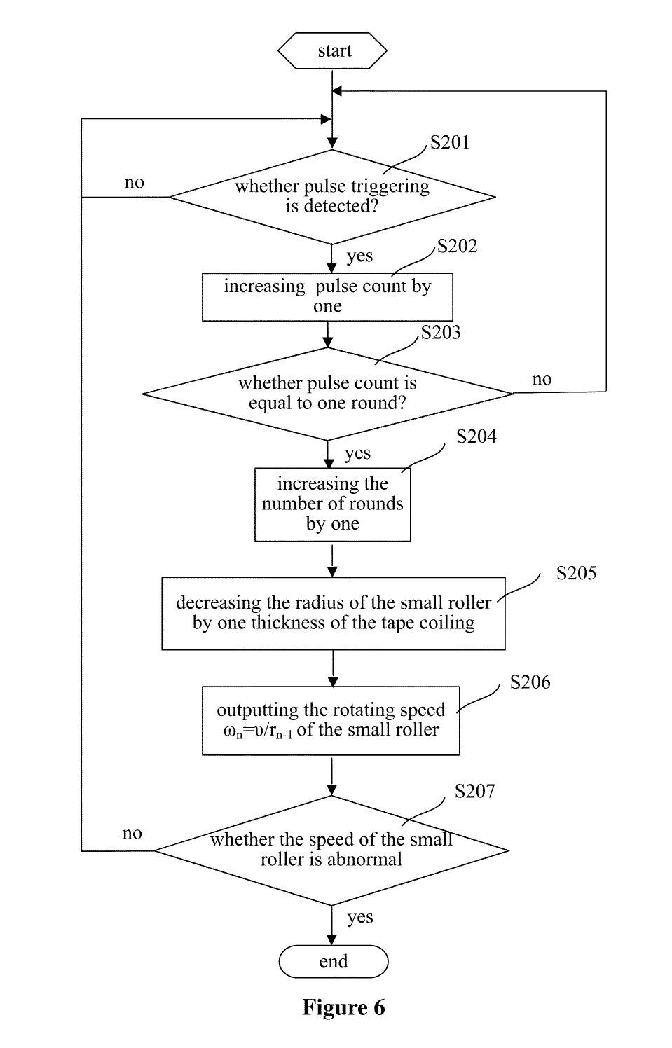

A method for controlling the rotation speed of the large reel/the small reel is described in the following. Referring to FIG. 6, a method for controlling a rotation speed of a small reel of a banknote temporary storage module in a process that a banknote enters into the banknote temporary storage module is provided according to a preferred embodiment of the disclosure, and the method includes following steps.

S201 includes: a system starting to operate, a banknote entering into the temporary storage module, and the reels running, a microcontroller monitoring an encoding disk of the small reel by an electric signal fed back by a second sensor, and determining whether a pulse triggering is detected, performing S202 if the pulse triggering is detected by the microcontroller and returning to S201 if no pulse triggering is detected by the microcontroller.

S202 includes: increasing a pulse counter of the small reel by one.

S203 includes: determining whether pulse count of the small reel is equal to one round, performing S204 if the pulse count of the small reel is equal to one round and returning to S201 if the pulse count of the small reel is not equal to one round.

S204 includes: increasing the number of rounds that the small reel rotates by one.

S205 includes: updating the rotation radius of the small reel by decreasing the rotation radius of the small reel by one thickness of the tape coiling for each round that the small reel rotates, and recording the rotation radius of the small reel for each round of the small reel into an array in a storage unit set in the microprocessor.

S206 includes: outputting the rotation speed of the small reel, calculating, according to the circular motion principle, the angular speed ωₙ=ν/rₙ₋₁ (n is a natural number) of the small reel for each round that the small reel rotates, outputting the calculated angular speed to a second motor corresponding to the small reel to control the rotation speed of the small reel, and performing S207.

S207 includes: monitoring whether the rotation speed of the small reel is abnormal, determining that the small reel is overspeed if it is monitored that the rotation speed of the small reel is greater than the output theoretical rotation speed and determining that the small reel is stalled if it is monitored that the rotation speed of the small reel is smaller than the output theoretical rotation speed; and if the rotation speed of the small reel is abnormal, stopping the power motors of the large reel and the small reel, or otherwise returning to S201.

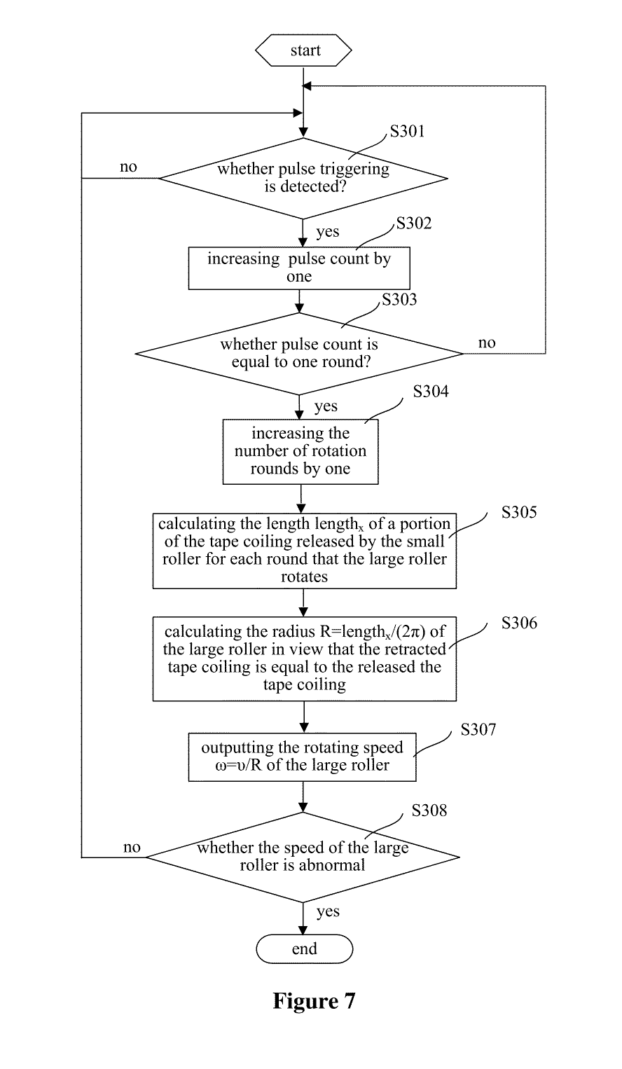

Referring to FIG. 7, a method for controlling a rotation speed of a large reel of a banknote temporary storage module in a process that a banknote enters into the banknote temporary storage module is provided according to a preferred embodiment of the disclosure, and the method includes following steps.

S301 includes: a system starting to operate, a banknote entering into the temporary storage module, the reels running, a microcontroller monitoring an encoding disk of the large reel by an electric signal fed back by a first sensor, determining whether a pulse triggering is detected, performing S302 if the pulse triggering is detected by the microcontroller and returning to S301 if no pulse triggering is detected by the microcontroller.

S302 includes: increasing a pulse counter of the large reel by one.

S303 includes: determining whether pulse count of the large reel is equal to one round, performing S304 if the pulse count of the large reel is equal to one round and returning to S301 if the pulse count of the large reel is not equal to one round.

S304 includes: increasing the number of rounds that the large reel rotates by one.

S305 includes: calculating a length of a portion of the tape coiling released by the small reel during the current round that the large reel rotates.

S306 includes: calculating and updating the radius of the large reel, and recording the radius of the large reel into a large reel radius array in the storage unit set in the microprocessor.

S307 includes: outputting the rotation speed of the large reel, calculating, according to ω=ν/R, an angular speed of the large reel, outputting the calculated angular speed to a first motor corresponding to the large reel to control the rotation speed of the large reel, and performing S308.

S308 includes: monitoring whether the rotation speed of the large reel is abnormal, determining that the large reel is overspeed if the rotation speed of the large reel is greater than the output theoretical rotation speed and determining that the large reel is stalled if the rotation speed of the large reel is smaller than the output theoretical rotation speed; and if the rotation speed of the large reel is abnormal, stopping the power motors of the large reel/the small reel, or otherwise returning to S301.

The process that the banknote leaves the temporary storage module is the reverse of the process that the banknote enters into the temporary storage module. The rotation speed of the power motor of the large reel/the small reel is adjusted according to the rotation radius of the large reel/the small reel for each round recorded during the process that the banknote enters into the temporary storage module, to keep linear speeds of the large reel/the small reel constant and consistent. The basic principles are related and are not described in detail here.

The above are merely embodiments of the disclosure, and the protection scope of the disclosure is not limited herein. Modifications or replacements easily thought by the persons of ordinary skill in the art within the technical scope disclosed by the disclosure are within the protection scope the invention. Hence, the protection scope of the disclosure should be subjected to the protection scope of the claims.

1. A banknote temporary storage module, comprising a large reel driven by a first power motor, a small reel driven by a second power motor, and a tape coiling, wherein two ends of the tape coiling are fixed on the large reel and the small reel respectively and the tape coiling is retractable wound between the large reel and the small reel, wherein the banknote temporary storage module further comprises:
a first encoding disk fixed on a rotating shaft of the large reel;
a second encoding disk fixed on a rotating shaft of the small reel;
a first sensor arranged corresponding to the first encoding disk and configured to monitor a rotation angle of the large reel;
a second sensor arranged corresponding to the second encoding disk and configured to monitor a rotation angle of the small reel; and
a microcontroller configured to calculate, based on output signals of the first sensor and the second sensor, a length of a portion of the tape coiling released by the small reel for every one round that the large reel rotates, and calculate a current radius of the large reel, to adjust and control angular speeds of the large reel and the small reel to make a linear speed of the large reel the same as a linear speed of the small reel.

2. The banknote temporary storage module according to claim 1, wherein the microcontroller comprises a storage unit configured to store a radius of the small reel for each round of the small reel and angular speed information of the first motor and the second motor for each round.

3. The banknote temporary storage module according to claim 1, wherein the microcontroller further comprises a pulse counter and a rotation round counter which correspond to the large reel, and a pulse counter and a rotation round counter which correspond to the small reel, wherein the pulse counters are respectively configured to record triggering to the large reel and triggering to the small reel, and the rotation round counters are respectively configured to record the number of rounds that the large reel rotates and the number of rounds that the small reel rotates.

4. The banknote temporary storage module according to claim 1, wherein the banknote temporary storage module further comprises a banknote counter.

5. The banknote temporary storage module according to claim 1, wherein the banknote temporary storage module further comprises a photoelectricity sensor configured to detect whether there is a banknote that enters into the banknote temporary storage module.

6. A method for controlling a rotation speed of a reel of a banknote temporary storage module, comprising:
step 1 which comprises: a banknote entering into the temporary storage module; a large reel retracting a tape coiling; and recording the number of rounds x that a small reel rotates during one round that the large reel rotates in a current state;
step 2 which comprises: calculating a length lengthₓ of a portion of the tape coiling released by the small reel based on the number of rounds that the small reel rotates and a radius of the small reel for each round of the small reel, wherein
$$\begin{matrix}{length}_{x} = {c}_{1} + {c}_{2} + … + {c}_{x} \\ = 2 π {r}_{0} + 2 π {r}_{1} + … + 2 π {r}_{x - 1} \\ = 2 π r + 2 π ( r - thick ) + … + 2 π [ r - ( x - 1 ) thick ] \\ = 2 π rx - x ( x - 1 ) {π}^{*} thick ;\end{matrix}$$
wherein c is a perimeter of the small reel for ever one round that the small reel rotates, thick is a thickness of the tape coiling, r is an initial radius of the small reel, and the radius r of the small reel decreases by one thickness of the tape coiling for every one round that the small reel rotates during a process that a banknote enters into the temporary storage module, and the radius of the small reel for each round of the small reel is pre-stored as an array in a storage unit of a microcontroller;
step 3 which comprises: calculating a current radius of the large reel based on the length of the portion of the tape coiling released by the small reel, wherein the length of the portion of the tape coiling released by the small reel is completely retracted by the large reel, wherein
$$\begin{matrix}{R}_{1} = {length}_{1} / ( 2 π ) \\ = {length}_{x} / ( 2 π ) \\ = [ 2 π rx - x ( x - 1 ) {π}^{*} thick ] / ( 2 π ) ;\end{matrix}$$
and
step 4 which comprises: adjusting an angular speed ω₂=ν/R₁ of a next round based on a current radius of the large reel, wherein ν is a preset target linear speed of the large reel and the small reel.

7. The method for controlling the rotation speed of the reel of the banknote temporary storage module according to claim 6, further comprising:
step 5 which comprises: recording the radius of the large reel for each round of the large reel during a process that the banknote enters into the banknote temporary storage module; and
step 6 which comprises: during a process that the banknote leaves the temporary storage module, the large reel releasing the tape coiling, and adjusting an angular speed of the large reel for each round that the large reel rotates based on the radius of the large reel for each round of the large reel recorded in step 5.

8. The method for controlling the rotation speed of the reel of the banknote temporary storage module according to claim 6, further comprising a method for controlling a rotation speed of a small reel which comprises:
S201 which comprises: a system starting to operate, a banknote entering into the temporary storage module, the reel running, a microcontroller monitoring an encoding disk of the small reel by an electric signal fed back by a second sensor, determining whether a pulse triggering is detected, performing S202 if the pulse triggering is detected by the microcontroller and returning to S201 if no pulse triggering is detected by the microcontroller;
S202 which comprises: increasing a pulse counter of the small reel by one;
S203 which comprises: determining whether pulse count of the small reel is equal to one round, performing S204 if the pulse count of the small reel is equal to one round and returning to S201 if the pulse count of the small reel is not equal to one round;
S204 which comprises: increasing the number of rounds that the small reel rotates by one;
S205 which comprises: updating a rotation radius of the small reel by decreasing the radius of the small reel by one thickness of the tape coiling for every one round that the small reel rotates, and recording the rotation radius of the small reel for each round that the small reel rotates into an array in the storage unit set in the microprocessor;
S206 which comprises: outputting a rotation speed of the small reel, calculating an angular speed ωₙ=ν/rₙ₋₁ (n is a natural number and represents the number of rounds that the small reel rotates) of the small reel for each round that the small reel rotates according to circular motion principle, outputting the calculated angular speed to a second motor corresponding to the small reel to control the rotation speed of the small reel, and performing S207; and
S207 which comprises: monitoring whether the rotation speed of the small reel is abnormal, determining that the small reel is overspeed if it is monitored that the rotation speed of the small reel is greater than the output theoretical rotation speed and determining that the small reel is stalled if it is monitored that the rotation speed of the small reel is smaller than the output theoretical rotation speed; and if the rotation speed of the small reel is abnormal, stopping power motors of the large reel and the small reel, or otherwise returning to S201.

9. The method for controlling the rotation speed of the reel of the banknote temporary storage module according to claim 6, wherein controlling the rotation speed of the large reel comprises:
S301 which comprises: a system starting to operate, a banknote entering into the temporary storage module, the reel running, the microcontroller monitoring an encoding disk of the large reel by an electric signal fed back by a first sensor, determining whether a pulse triggering is detected, performing S302 if the pulse triggering is detected by the microcontroller and returning to S301 if no pulse triggering is detected by the microcontroller;
S302 which comprises: increasing a pulse counter of the large reel by one;
S303 which comprises: determining whether pulse count of the large reel is equal to one round, performing S304 if the pulse count of the large reel is equal to one round and returning to S301 if the pulse count of the large reel is not equal to one round;
S304 which comprises: increasing the number of rounds that the large reel rotates by one;
S305 which comprises: calculating a length lengthₓ of a portion of the tape coiling released by the small reel during a current round that the large reel rotates;
S306 which comprises: calculating and updating a radius R=lengthₓ/(2π) of the large reel, and recording the radius of the large reel into a large reel radius array in the storage unit set in the microprocessor;
S307 which comprises: outputting a rotation speed of the large reel, calculating an angular speed of the large reel according to ω=ν/R, outputting the calculated angular speed to a first motor corresponding to the large reel to control the rotation speed of the large reel, and performing S308; and
S308 which comprises: monitoring whether the rotation speed of the large reel is abnormal, determining that the large reel is overspeed if the rotation speed of the large reel is greater than the output theoretical rotation speed and determining that the large reel is stalled if the rotation speed of the large reel is smaller than the output theoretical rotation speed; and if the rotation speed of the large reel is abnormal, stopping power motors of the large reel and the small reel, or otherwise returning to S301.
